(19) United States
(12) Patent Application Publication
(10) Pub. No.: US 2023/0040611 A1
(43) Pub. Date: Feb. 9, 2023

(54) CLEANING APPARATUS AND CONTROL METHOD THEREOF

(71) Applicant: LG ELECTRONICS INC., Seoul (KR)

(72) Inventor: Byungryul MOON, Seoul (KR)

(73) Assignee: LG ELECTRONICS INC., Seoul (KR)

(21) Appl. No.: 17/788,927

(22) PCT Filed: Nov. 17, 2020
(86) PCT No.: PCT/KR2020/016116

§ 371 Date: Jun. 24, 2022

(30) Foreign Application Priority Data
Jan. 10, 2020 (KR) 10-2020-0003903

(51) Int. Cl. A47L 9/28

(52) U.S. Cl. CPC A47L 9/2842; A47L 9/2889; A47L 9/2894; A47L 9/2805; A47L 9/2873

(57) ABSTRACT

Disclosed are a cleaning apparatus and a control method thereof. A cleaning apparatus according to the present specification, comprising a cleaning module and a main body, comprises: a motor for suctioning air outside the cleaning apparatus; a sensor which is included in the cleaning module and detects a facing distance between the cleaning module and a facing surface while the motor is operating; and a processor which controls the output of the motor on the basis of the facing distance. Thus, even without an additional operation by the user, it is possible to pre-emptively protect a user from injury by a brush that rotates while externally exposed, on the basis of the distance between the cleaning module and the floor surface.

### TECHNICAL FIELD

The present disclosure relates to a cleaning apparatus and a control method thereof, and more particularly, to a cleaning apparatus and a control method thereof, which variably control an output of a nozzle.

### BACKGROUND ART

In general, cleaners are home appliances that suck small garbage or dust in a manner of sucking air using electricity and fill it in dust bins in products, and are generally called vacuum cleaners.

Such a cleaner may be classified into a manual cleaner for performing cleaning while the user directly moves the cleaner, and an automatic cleaner for performing cleaning while driving by itself. The manual cleaner may be classified into a canister vacuum cleaner, an upright vacuum cleaner, a hand vacuum cleaner, and a stick vacuum cleaner or the like depending on the type of the cleaner.

In the household cleaners, the canister vacuum cleaner was used a lot in the past, but recently, the hand vacuum cleaner and the stick vacuum cleaner, which improve the convenience of use by providing a dust box and a cleaner body integrally, have been used a lot.

The canister vacuum cleaner has a main body and a suction port connected by a rubber hose or a pipe and, in some cases, can be used with a brush attached to the suction port.

The hand vacuum cleaner maximizes portability, and it is light in weight but short in length, so there may be limitations in sitting area for cleaning. Therefore, it is used to clean local places such as on a desk or sofa or in a car.

The stick vacuum cleaner can be used with standing and can be used without bowing. Therefore, it is advantageous for cleaning while moving in a large area. If the hand vacuum cleaner cleans a small area, the stick vacuum cleaner can clean a wider area and a high place out of reach. Recently, the stick vacuum cleaner is provided as a modular type, and it is also used to actively change the cleaner type for various objects.

In addition, recently, the hand vacuum cleaner and the stick vacuum cleaner are provided to be used in combination, and products that improve user convenience have been released.

Meanwhile, a brush provided in a nozzle part (cleaning module part) of the cleaner is exposed to the outside, and foreign substances on a floor surface are configured to be suctioned while the brush being in contact with the floor surface. The brush is rotated by an internal motor when a micro-switch provided in the nozzle part is turned on, an output (a rotational speed) is varied by a manipulation of the user, and when the micro-switch is turned off, the brush stops to rotate as operating of the internal motor is stopped.

However, in a state in which there is no manipulation of the user or no input for the micro-switch, a part (e.g., finger) of a body of a person (e.g., infant) is in contact with the brush, and as a result, there is a risk that the person is hurt.

Further, in general, a cross section of the brush has a circular shape so as to be rotatable, and as a result, foreign substances in a corner space between the floor surface and a wall surface cannot be easily suctioned. There is a disadvantage in that in order to suction the foreign substances at a corner, the user should adjust the output of the brush by separate manipulation.

### DISCLOSURE

### Technical Problem

An object of the present disclosure is to provide a cleaning apparatus and a control method thereof in order to solve the problem.

Further, an object of the present disclosure is to provide a cleaning apparatus capable of protecting a person from a cleaning module exposed to the outside.

Further, an object of the present disclosure is to provide a cleaning apparatus capable of effectively suctioning foreign substances in a corner space between a wall surface and a floor surface.

### Technical Solution

According to an embodiment of the present disclosure, a control method of a cleaning apparatus may include: operating at least one motor for suctioning air outside the cleaning apparatus; acquiring a facing distance between a cleaning module of the cleaning apparatus and a facing surface of the cleaning module while the at least one motor is operating; and controlling an output of the at least one motor based on the facing distance.

Further, in the controlling, when the facing distance is larger than a predetermined upperlimit value, the output of the at least one motor may be decreased.

Further, in the controlling, when the facing distance is larger than the predetermined upperlimit value, the operating of the at least one motor may be stopped.

Further, in the controlling, when the facing distance is larger than the predetermined upperlimit value, the output of a nozzle motor of the cleaning module among the at least one motor may be controlled.

Further, in the controlling, when the facing distance is smaller than a predetermined lowerlimit value, the output of the at least one motor may be increased.

Further, in the controlling, when the facing distance is smaller than the predetermined lowerlimit value, the output of the at least one motor may be set to a maximum value.

Further, in the controlling, when the facing distance is larger than the predetermined lowerlimit value, the output of a body suction motor of the cleaning apparatus among the at least one motor may be controlled.

Further, the controlling may include changing the output of the at least one motor from a first output value to a second output value based on a change of the facing distance, and the method may further include restoring the output of the at least one motor from the second output value to the first output when a predetermined time elapsed after the controlling.

Further, the facing distance may be generated by using distance sensor values of a plurality of sensors directing a direction in which forms an acute angle with a normal of a bottom surface.

Further, the plurality of sensors may be included in the cleaning module, and in the acquiring of the facing distance, the facing distance may be acquired from the cleaning module through power line communication.

According to an embodiment of the present disclosure, a cleaning apparatus including a cleaning module and a body includes: at least one motor for suctioning air outside the cleaning apparatus; at least one sensor included in the cleaning module, and detecting a facing distance between the cleaning module and a facing surface while the at least one motor is operating; and at least one processor controlling an output of the at least one motor based on the facing distance.

Further, wherein when the facing distance is larger than a predetermined upperlimit value, the processor may decrease the output of the at least one motor.

Further, when the facing distance is larger than the predetermined upperlimit value, the processor may stop the operating of the at least one motor.

Further, when the facing distance is larger than the predetermined upperlimit value, the processor may control the output of a nozzle motor of the cleaning module among the at least one motor.

Further, when the facing distance is smaller than a predetermined lowerlimit value, the processor may increase the output of the at least one motor.

Further, when the facing distance is smaller than the predetermined lowerlimit value, the processor may set the output of the at least one motor to a maximum value.

Further, when the facing distance is smaller than the predetermined lowerlimit value, the processor may control the output of a body suction motor of the cleaning apparatus among the at least one motor.

Further, the processor may change the output of the at least one motor from a first output value to a second output value based on a change of the facing distance, and restore the output of the at least one motor from the second output value to the first output value when a predetermined time elapsed after the output value is changed.

Further, the at least one sensor may direct a direction which forms an acute angle with a normal of a bottom surface.

Further, a body processor included in the cleaning apparatus body among the at least one processor may acquire the facing distance from a cleaning module processor included in the cleaning module among the at least one processor.

### Advantageous Effect

A cleaning apparatus and a control method thereof according to the present disclosure can prevent an injury of a user by a brush which is exposed to the outside and rotated based on a distance between a cleaning module and a floor surface without a separate manipulation of the user.

Further, according to at least one of embodiments of the present disclosure, a cleaning apparatus and a control method thereof automatically control a rotational output of the brush of the cleaning module based on the distance between the cleaning module and the wall surface without a separate manipulation of the user to easily remove foreign substances in a corner space.

Further, according to at least one of embodiments of the present disclosure, the cleaning apparatus and the control method thereof can effectively detect the distance from the cleaning module to the floor surface or the wall surface by arranging a distance sensor in a front-downward direction.

Further, according to at least one of embodiments of the present disclosure, the cleaning apparatus and the control method thereof automatically stop a motor of the cleaning module when the cleaning module is separated from the floor surface and automatically operate the motor when the cleaning module is in contact with the floor surface again to increase a battery use time of the cleaning apparatus.

Further, according to at least one of embodiments of the present disclosure, the cleaning apparatus and the control method thereof suction foreign substances in various types of spaces without a separate manipulation to increase the battery use time of the cleaning apparatus and increase convenience of the user.

### DESCRIPTION OF DRAWINGS

FIG. 1 is a view illustrating a configuration for control of a vacuum cleaner according to an embodiment of the present disclosure.

FIG. 2 is a control block diagram of each component constituting a control system of a vacuum cleaner and a smart device.

FIG. 3 illustrates a customized cleaning information providing apparatus according to an embodiment of the present disclosure.

FIG. 4 is a black diagram illustrating an example of a processor of FIG. 3.

FIG. 5 is an exploded perspective view illustrating a vacuum cleaner according to an embodiment.

FIG. 6 is a diagram illustrating a control method of a vacuum cleaner according to an embodiment.

FIG. 7 is a block diagram illustrating a connection relationship of a vacuum cleaner.

FIG. 8 is a cross-sectional view illustrating a coupling part of a cleaner body and a cleaning module according to a first embodiment.

FIG. 9 is a plan view illustrating coupling parts of a cleaner body and a cleaning module according to a first embodiment, respectively.

FIG. 10 is a plan view illustrating a coupling part of a cleaner body and a cleaning module according to a second embodiment, respectively.

FIG. 11 is a flowchart illustrating a control method of a cleaning apparatus according to an embodiment of the present disclosure.

FIG. 12 illustrates a cleaning module according to an embodiment of the present disclosure.

FIG. 13 is a block diagram of a cleaning apparatus body and a cleaning module according to an embodiment of the present disclosure.

FIG. 14 is a block diagram of a cleaning apparatus body and a cleaning module according to another embodiment of the present disclosure.

FIG. 15 illustrates one example of a process of controlling a nozzle motor based on a distance sensor value.

FIG. 16 illustrates another example of the process of controlling the nozzle motor based on the distance sensor value.

FIG. 17 illustrates yet another example of the process of controlling the nozzle motor based on the distance sensor value.

FIG. 18 illustrates one example of a process of controlling a suction motor based on the distance sensor value.

FIG. 19 illustrates another example of the process of controlling the suction motor based on the distance sensor value.

### MODE FOR DISCLOSURE

Hereinafter, with reference to the accompanying drawings will be described in detail an embodiment disclosed in the present disclosure, however, the same or similar components regardless of the reference numerals are given the same reference numerals and redundant description thereof will be omitted.

In describing the embodiments disclosed in the present disclosure, when a component is referred to as being “coupled” or “connected” to another component, it may be directly coupled to or connected to the other component, however, it should be understood that other components may exist in the middle.

In addition, in describing the embodiments disclosed in the present disclosure, when it is determined that the detailed description of the related known technology may obscure the gist of the embodiments disclosed in the present disclosure, the detailed description thereof will be omitted. In addition, the accompanying drawings are only for easily understanding of the embodiments disclosed in the present disclosure, but the technical spirit disclosed in the present disclosure is not limited by the accompanying drawings, and it should be understood that the accompanying drawings include all changes, equivalents, and substitutes included in the spirit and scope of the present disclosure.

On the other hand, the term “disclosure” may be replaced with terms such as document, specification, description.

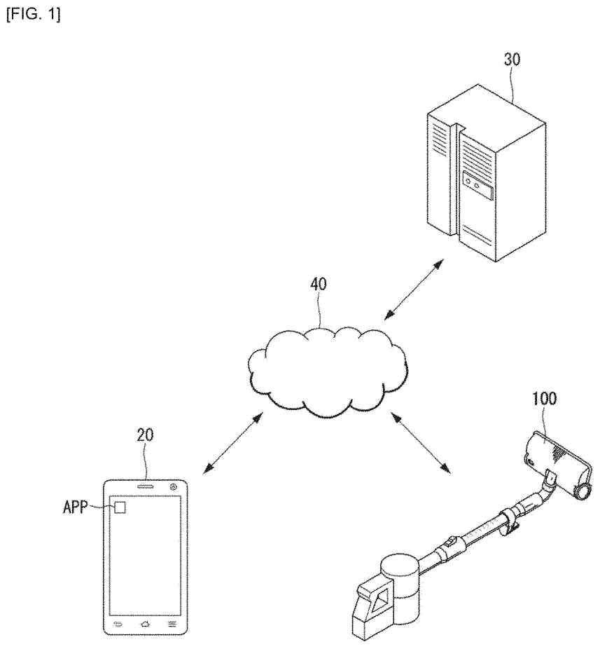

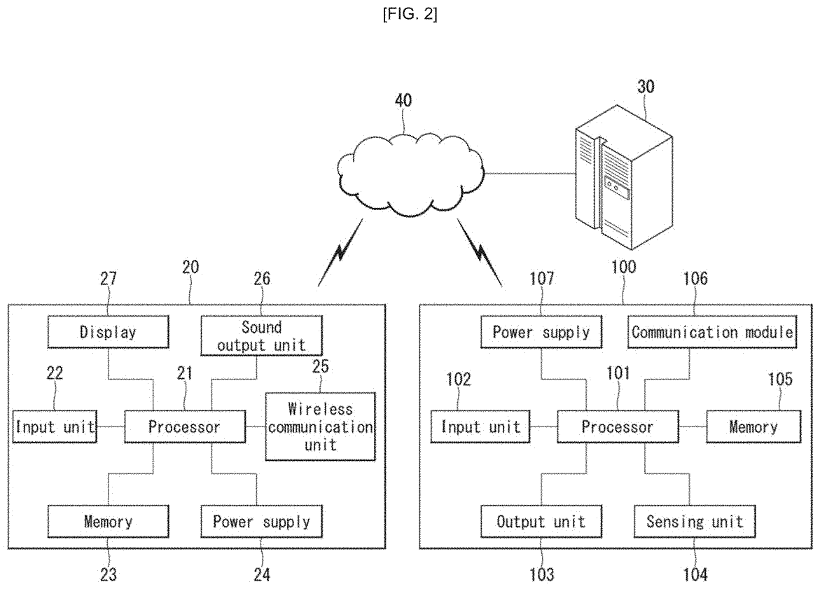

FIG. 1 is a view illustrating a configuration for control of a vacuum cleaner 100 according to an embodiment of the present disclosure, and FIG. 2 is a control block diagram of each component constituting a control system of a vacuum cleaner 100 and a smart device 20.

Referring to FIG. 1, a control system of a vacuum cleaner 100 according to an embodiment of the present disclosure may include a vacuum cleaner 100, a smart device 20 equipped with an application (APP) for controlling or managing the vacuum cleaner 100, a server 30 for managing the application 30, and the internet 40 for communication among the smart device 20, the vacuum cleaner 100, and the server 30.

Referring to FIG. 2, the vacuum cleaner 100 may include a processor 101, an input unit 102, an output unit 103, a sensing unit 104, a memory 105, a communication module 106, and a power supply 107.

The processor 101 may include a controller. For example, it may include a micro controller unit (MCU).

The input unit 102 may be formed in a control panel provided near a handle of the vacuum cleaner 100, and may be provided in the form of a touch button or a push button. Alternatively, the input unit 102 may be provided in a microphone form to recognize a voice command. In addition, an input unit including a camera or an image sensor may be provided to recognize a gesture of a user.

The output unit 103 may include a display provided as an image output unit and a speaker provided as a sound output unit.

The display may be provided in the control panel or provided as a separate display area, and may include an LCD panel on which an image or a video is output. Alternatively, the display may simply include a singular light emitting unit or a plurality of light emitting units.

The speaker may output a selection sound, a warning sound, a cleaning start or cleaning completion notification signal, and the like. In addition, the speaker may be provided in an area other than the handle that can be grabbed by the user.

The sensing unit 104 may include a current sensor for detecting a current value (or voltage value) of a driver to be described later, a load sensor for detecting a load of the driver, a torque sensor for detecting a torque of the driver, and a timer for detecting an operation hour and time.

The memory 105 may include DRAM (RAM that requires refreshing), SRAM (RAM that does not require refreshing), ROM, EPROM, EEPROM, and the like.

In addition, the communication module 106 may include a wired communication module including a power line communication (PLC) capable of the internet communication or a wireless communication module including Wi-Fi. The communication module 106 may include a transceiver or an antenna. The transceiver may include a transmitter and a receiver.

In addition, the vacuum cleaner 100 may further include a power supply 107 and the driver for operating the vacuum cleaner 100. The driver may include a driving motor or a motor pump. The driving motor may include a main driving motor that is installed in a cleaner body to generate a suction force and an auxiliary driving motor that is installed in a suction nozzle provided at a suction end of the vacuum cleaner to generate a rotational force of a roller and the like.

On the other hand, the smart device 20 may include a smart phone that the user can carry. The smart device 20 may include a processor 21, an input unit 22, a memory 23, a power supply 24, a wireless communication unit 25, a sound output unit 26, and a display 27.

The input unit 22 may include a touch type button for inputting a command by touching the display 27.

In addition, the wireless communication unit 25 may be a wireless communication module capable of communicating with the internet 40.

In addition, the sound output unit 26 may include a speaker.

According to the above configuration, the user may execute the application (APP) for managing or controlling the vacuum cleaner 100 installed in the smart device 20, and may check a management state of the vacuum cleaner 100 or input a control command through this application. In addition, the user may receive information related to the management state of the vacuum cleaner 100 stored in the server 30 through the internet 40 to the smart device 20. The control command input to the smart device 20 is transmitted to the server 30 of the application through the internet 40, and the server 30 may transmit a control command to the communication module 106 of the vacuum cleaner 100 through the internet 40.

In addition, the control command received through the communication module 106 is received to the processor 101 of the vacuum cleaner 100, and the processor 101 may control the operation of the driver according to the received control command.

In addition, the processor 101 of the vacuum cleaner 100 may transmit an event occurring in the cleaning process and being received from the sensing unit 104 via wire or wireless through the communication module 106. The event information transmitted through the communication module 106 of the vacuum cleaner 100 may be transmitted to the server 30 through the internet 40. In addition, the server 30 may transmit the received event information to the wireless communication unit 25 of the smart device 20 through the internet 40.

In addition, the event information received by the wireless communication unit 25 may be displayed on the display 27 by the processor 21 of the smart device 20.

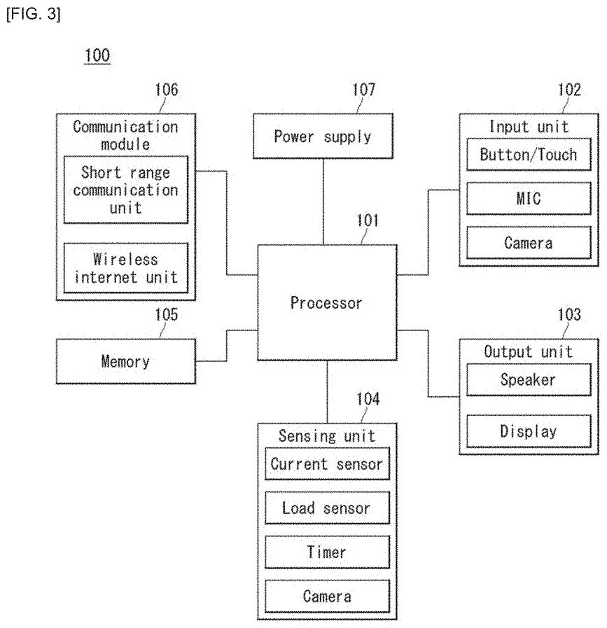

FIG. 3 illustrates a customized cleaning information providing apparatus 100 according to an embodiment of the present disclosure.

Referring to FIG. 3, the customized cleaning information providing apparatus 100 may include a processor 101, an input unit 102, an output unit 103, a sensing unit 104, a memory 105, a communication module 106, and/or a power supply 107.

The processor 101 may include a controller. For example, it may include a micro controller unit (MCU).

The input unit 102 may include a physical button or a touch button that receives a physical signal or a touch signal from outside and a microphone that receives an audio signal based on the control of the processor 101. In addition, the input unit 102 may include a camera or an image sensor that receives an image from outside based on the control of the processor 101.

The output unit 103 may include a speaker that outputs an audio signal based on the control of the processor 101. For example, the speaker may provide the customized cleaning information in a form of the audio signal.

The output unit 103 may include a display for outputting visual information based on the control of the processor 101. The display may implement a touch screen by forming a layer structure or integrally with the touch sensor. The touch screen may function as a user input unit that provides an input interface between the customized cleaning information providing apparatus 100 and the user, at the same time, and may provide an output interface between the customized cleaning information providing apparatus 100 and the user. For example, the display may obtain information for user registration from the user. In addition, the display may output the customized cleaning information to the user in the form of visual information. That is, the display may be the input interface of the customized cleaning information providing apparatus 100 and, at the same time, may be the output interface of the customized cleaning information providing apparatus 100.

The sensing unit 104 may include sensors for sensing information of any one or more of a current, a voltage, a load, and a torque of the driver of the customized cleaning information providing apparatus 100. In addition, the sensing unit 104 may include a timer capable of knowing an operating hour and an operating time of the driver. In addition, the sensing unit 104 may include a camera or an image sensor to detect the user or an obstacle.

The memory 105 stores data that supports various functions of the customized cleaning information providing apparatus 100. The memory 105 may store a plurality of application programs or applications driven in the customized cleaning information providing apparatus 100, data and instructions for operating the customized cleaning information providing apparatus 100. At least some of these applications may be downloaded from an external server through wireless communication. In addition, at least some of these application programs may exist on the customized cleaning information providing apparatus 100 from the time of shipment for basic functions (e.g. functions of receiving and transmitting data) of the customized cleaning information providing apparatus 100. On the other hand, the application program may be stored in the memory 105, installed on the customized cleaning information providing apparatus 100, so that the application program may be driven by the processor 101 to perform an operation (or function) of the customized cleaning information providing apparatus 100.

The communication module 106 may include one or more modules that enable wireless communication between the customized cleaning information providing apparatus 100 and the wireless communication system, between the customized cleaning information providing apparatus 100 and other customized cleaning information providing apparatus, or between the customized cleaning information providing apparatus 100 and the external server. In addition, the communication module 106 may include one or more modules for connecting the customized cleaning information providing apparatus 100 to one or more networks. Here, the communication module 106 may be connected to the 5G communication system. The communication module 106 may perform wireless communication with other customized cleaning information providing apparatus, an external server or an external apparatus (e.g. a mobile terminal) through the 5G communication system.

The communication module 106 may include at least one of a short range communication unit and a wireless internet unit.

The wireless internet unit refers to a module for wireless internet access, and may be built in or external to the customized cleaning information providing apparatus 100. The wireless internet unit is configured to transmit and receive wireless signals in a communication network based on wireless internet technologies.

The wireless internet technologies include, for example, WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc., and the wireless internet unit transmits and receives data based on at least one wireless internet technology in a range including internet technologies not listed above.

If the wireless internet access by WiBro, HSDPA, HSUPA, GSM, CDMA, WCDMA, LTE, LTE-A, etc. is made through a mobile communication network, the wireless internet unit for performing wireless internet access through the mobile communication network may be understood as a kind of the mobile communication module.

The short range communication unit is for short range communication, and the short range communication unit may support the short range communication using at least one of Bluetooth, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technology. Such a short range communication unit may support wireless communication between the customized cleaning information providing apparatus 100 and the wireless communication system, between the customized cleaning information providing apparatus 100 and other customized cleaning information providing apparatus, or between the customized cleaning information providing apparatus 100 and a network in which another mobile terminal (or an external server) is located through wireless area networks. The short range wireless communication networks may be short range wireless personal area networks.

Here, the other customized cleaning information providing apparatus may be an apparatus capable of exchanging (or interlocking) data with the customized cleaning information providing apparatus 100 according to the present disclosure. The short range communication unit, around the customized cleaning information providing apparatus 100, may detect (or recognize) other customized cleaning information providing apparatus that can communicate with the customized cleaning information providing apparatus 100. Furthermore, when the detected other customized cleaning information providing apparatus is a customized cleaning information providing apparatus certified to communicate with the customized cleaning information providing apparatus 100 according to the present disclosure, the processor 101 may transmit at least a part of data processed by the customized cleaning information providing apparatus 100 to the other customized cleaning information providing apparatus through the short range communication unit. Therefore, the user of the other customized cleaning information providing apparatus may use data processed by the customized cleaning information providing apparatus 100 through the other customized cleaning information providing apparatus. For example, according to this, the user can receive cleaning information from the customized cleaning information providing apparatus 100, and output the cleaning information through a display of the other customized cleaning information providing apparatus 100.

The power supply 107 receives power from an external power source and an internal power source under the control of the processor 101 to supply power to each component included in the customized cleaning information providing apparatus 100. The power supply 107 includes a battery, which may be a built-in battery or a replaceable battery.

According to an embodiment of the present disclosure, the processor 101 may control the input unit 102, the output unit 103, the sensing unit 104, the memory 105, the communication module 106, and the power supply 107.

According to an embodiment of the present disclosure, the processor 101 may control the input unit 102 and the output unit 103 to provide customized cleaning information.

According to an embodiment of the present disclosure, the processor 101 may control the sensing unit 104 to obtain information necessary for the customized cleaning information providing apparatus 100. For example, the processor 101 may obtain current/voltage values, load values, torque values, operating hour and operating time information, user recognition information, and/or obstacle detection information from the sensing unit 104.

According to an embodiment of the present disclosure, the processor 101 may obtain a plurality of user's face images stored in the memory 105, and may generate/learn a face classification model for classifying a users face by using (meta learning) only a predetermined number of images among the plurality of user's face images. In addition, the processor 101 may obtain images of a plurality of food items stored in the memory 105, and may generate/learn a food classification model for classifying food using only a predetermined number of images among the plurality of food images.

According to an embodiment of the present disclosure, the processor 101 may control the communication module 106 to transmit the customized cleaning information to an external mobile terminal.

Detailed description of the function/operation of the processor 101 will be described in detail later.

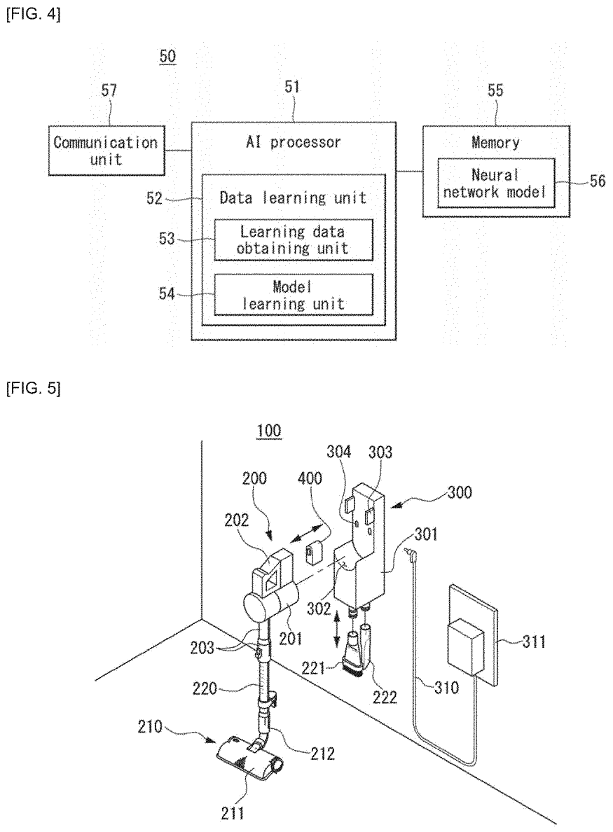

FIG. 4 is a black diagram illustrating an example of a processor of FIG. 3.

As shown in FIG. 4, a processor of FIG. 4 may be an AI device 50, but is not necessarily limited thereto.

The AI device 50 may include an electronic device including an AI module capable of performing AI processing or a server including the AI module. In addition, the AI device 50 may be included in at least a part of the customized cleaning information providing apparatus 100 illustrated in FIG. 3 and may be provided to perform at least some of the AI processing together.

The AI processing may include all operations related to the control of the customized cleaning information providing apparatus 100 shown in FIG. 3. For example, the customized cleaning information providing apparatus 100 may perform processing/determination and control signal generation by performing the AI processing of the sensing data or the obtained data. In addition, for example, the customized cleaning information providing apparatus 100 may control an intelligent electronic device by performing the AI processing of the data received through the communication unit.

The AI device 50 may be a client device that directly uses an AI processing result, or a device of a cloud environment that provides the AI processing result to another device.

The AI device 50 may include an AI processor 51, a memory 55, and/or a communication unit 57.

The AI device 50 is a computing device capable of learning neural networks, and may be implemented as various electronic devices such as a server, a desktop PC, a notebook PC, a tablet PC, and the like.

The AI processor 51 may learn a neural network using a program stored in the memory 55. In particular, the AI processor 51 may learn a neural network for recognizing vehicle-related data. Here, the neural network for recognizing vehicle-related data may be designed to simulate a human brain structure on a computer, and may include a plurality of network nodes having weights, which simulate the neurons of a human neural network. A plurality of network modes may transmit and receive data according to each connection relationship so that neurons simulate the synaptic activity of neurons that transmit and receive signals through synapses. Here, the neural network may include a deep learning model developed from the neural network model. In the deep learning model, the plurality of network nodes may be located at different layers and transmit and receive data according to a convolutional connection relationship. Examples of the neural network models may include various deep learning techniques, such as deep neural networks (DNNs), convolutional deep neural networks (CNNs), recurrent boltzmann machines (RNNs), restricted boltzmann machines (RBMs), and deep belief networks (DBN), and Deep Q-Network, and may be applied to fields such as computer vision, speech recognition, natural language processing, speech/signal processing, and the like.

On the other hand, the processor that performs the function described above may be a general purpose processor (e.g. CPU), but may be an AI dedicated processor (e.g. GPU) for artificial intelligence learning.

The memory 55 may store various programs and data necessary for the operation of the AI device 50. The memory 55 may be implemented as a nonvolatile memory, a volatile memory, a flash-memory, a hard disk drive (HDD), or a solid state drive (SDD), etc. The memory 55 may be accessed by the AI processor 51, and may read/write/modify/delete/update the data by the AI processor 51. In addition, the memory 55 may store a neural network model (e.g. deep learning model 56) generated through a learning algorithm for data classifying/recognizing according to an embodiment of the present disclosure.

On the other hand, the AI processor 51 may include a data learning unit 52 for learning the neural network for the data classification/recognition. The data learning unit 52 may learn a criterion about what learning data to use to determine the data classification/recognition and how to classify and recognize the data using the learning data. The data learning unit 52 may learn the deep learning model by obtaining the learning data to be used for learning and applying the obtained learning data to the deep learning model.

The data learning unit 52 may be manufactured in a form of at least one hardware chip and mounted on the AI device 50. For example, the data learning unit 52 may be manufactured in a form of a dedicated hardware chip for artificial intelligence (AI), or may be manufactured as a part of a general purpose processor (CPU) or a graphics dedicated processor (GPU) and mounted on the AI device 50. In addition, the data learning unit 52 may be implemented as a software module. When implemented as a software module (or a program module including instructions), the software module may be stored in a computer readable non-transitory computer readable recording media. In this case, at least one software module may be provided by an operating system (OS) or by an application.

The data learning unit 52 may include a learning data obtaining unit 53 and a model learning unit 54.

The learning data obtaining unit 53 may obtain learning data necessary for a neural network model for classifying and recognizing data. For example, the learning data obtaining unit 53 may obtain vehicle data and/or sample data for input to the neural network model as the learning data.

The model learning unit 54 may learn to have a criterion about how the neural network model classifies predetermined data using the obtained learning data. In this case, the model learning unit 54 may learn the neural network model through supervised learning that uses at least some of the learning data as a criterion. Alternatively, the model learning unit 54 may learn the neural network model through unsupervised learning that finds a criterion by self-learning using the learning data without guidance. In addition, the model learning unit 54 may learn the neural network model through reinforcement learning using feedback on whether the result of the situation determination according to the learning is correct. In addition, the model learning unit 54 may learn the neural network model using learning algorithms that include error back-propagation or gradient decent.

When the neural network model is learned, the model learning unit 54 may store the neural network model in the memory. The model learning unit 54 may store the learned neural network model in the memory of the server connected to the AI device 50 through a wired or wireless network.

The data learning unit 52 may further include a learning data preprocessor (not shown) and a learning data selector (not shown) in order to improve analysis results of a recognition model, or to save resources or time required for generating the recognition model.

The learning data preprocessor may preprocess the obtained data so that the obtained data may be used for learning for situation determination. For example, the learning data preprocessor may process the obtained data in a preset format so that the model learning unit 54 may use the obtained learning data for learning for image recognition.

In addition, the learning data selector may select data necessary for learning among the learning data obtained by the learning data obtaining unit 53 or the learning data preprocessed by the preprocessor. The selected learning data may be provided to the model learning unit 54. For example, the learning data selector may select only data for an object included in a specific area as learning data by detecting a specific area of an image obtained through a camera of the intelligent electronic device.

In addition, the data learning unit 52 may further include a model evaluator (not shown) to improve analysis results of the neural network model.

The model evaluator may input the evaluation data into the neural network model, and when the analysis result output from the evaluation data does not satisfy a predetermined criterion, may allow the model learning unit 54 to learn again. In this case, the evaluation data may be predefined data for evaluating the recognition model. For example, among the analysis results of the learned recognition model on the evaluation data, when the number or ratio of evaluation data that is not accurate in analysis results exceeds a preset threshold, the model evaluator may evaluate that a predetermined criterion is not satisfied.

The communication unit 57 may transmit the AI processing result by the AI processor 51 to an external electronic device.

The external electronic device may include an autonomous vehicle, a robot, a drone, an AR device, a mobile device, a home appliance, and the like.

For example, when the external electronic device is the autonomous vehicle, the AI device 50 may be defined as another vehicle or 5G network that communicates with the autonomous module vehicle. On the other hand, the AI device 50 may be implemented by being functionally embedded in the autonomous module provided in the vehicle. In addition, the 5G network may include a server or a module that performs autonomous related control.

On the other hand, the AI device 50 illustrated in FIG. 4 has been described to functionally be divided into the AI processor 51, the memory 55, the communication unit 57, and the like, but it should be noted that the above-described components may be integrated into one module and may be referred to as AI modules.

FIG. 5 is an exploded perspective view illustrating a vacuum cleaner 100 according to an embodiment.

Referring to FIG. 5, a vacuum cleaner 100 may include a cleaner body 200, a cleaning module 210 coupled to the cleaner body 200, a length adjusting member 220 for connecting the cleaner body 200 and the cleaning module 210, a battery 400 coupled to the cleaner body 200, and a cleaner holder 300 on which the cleaner body 200 is mounted.

The cleaner body 200 may include a body part 201 in which a suction motor (not shown) for generating a suction force and a cyclone flower (not shown) for separating dust from the sucked air are installed, a handle part 202 connected to the back of the body part 201 and grabbed by the user, a connecting part 203 connected to the front of the body part 201 and coupled to the cleaning module 210 or the length adjusting member 220.

The cleaning module 210 may include a suction part 211 that sucks dust and the like, and a coupling part 212 coupled to the cleaner body 200 or the length adjusting member 220.

One end of the length adjusting member 220 may be coupled to the cleaner body 200, and the other end of the length adjusting member 220 may be coupled to the cleaning module 210. The length adjusting member 220 may employ a structure in which the length is variable. The length adjusting member 220 may employ a material that can be elastically changed. The one end of the length adjusting member 220 may be coupled to the cleaner body 200, and a suction part (not shown) is provided at the other end so that a suction function can be performed without coupling of a separate cleaning module.

The battery 400 may be detachably connected to the body part 201 of the cleaner body 200 to supply power for driving the vacuum cleaner 100. The battery 400 may be detachably connected to a battery accommodating part 302 of the cleaner holder 300 to be rechargeable. Two batteries 400 are provided, one is coupled to the cleaner body 200 to supply power, and the other is coupled to the cleaner holder 300 to be charged.

The cleaner holder 300 may include a stand-type or wall-type body 301, a battery accommodating part 302 in which the battery 400 is charged, a cleaner support part 303 which supports the cleaner body 200, a charging part 304 electrically connected to the battery 400 coupled to the cleaner body 200.

Although the drawing shows the wall-type body 301, it may alternatively include the stand-type body (not shown) provided in a standing state on the floor.

The battery 400 may be electrically connected to the charging part 304 while the cleaner body 200 is supported by the cleaner support part 303. Therefore, the user may charge the battery 400 while placing the cleaner body 200 on the cleaner holder 300.

The cleaner holder 300 may be electrically connected to an external outlet 311 through a power line 310. A current transmitted through the power line 310 may charge a first battery accommodated in the cleaner body 200 through the charging part 304 of the cleaner holder, and charge a second battery mounted on the battery accommodating part 302.

In addition, in the vacuum cleaner 100, the suction part performing various functions may be modularly mounted on the cleaner body 200. That is, the cleaning module 210 is provided with a plurality of functions, and the user may use the cleaning module 210 suitable for the cleaning object in combination with the cleaner body 200.

The cleaning module 210 may include a cleaning module having a basic wood floor suction port, a cleaning module having a bedding suction port, a cleaning module having a mattress suction port, a cleaning module having a carpet suction port, and a cleaning module having a mop, etc. In addition, a dedicated cleaning module for performing various functions, such as for hard dust, bending gaps, upper cleaning may be provided as a module.

The drawing shows that a cleaning module 221 having a 2 in 1 suction port and a cleaning module 222 having a suction hole for gaps are mounted on the cleaner holder 300. The cleaning module 221 having the 2 in 1 suction port may be used as a basic type when cleaning a sofa or a mattress and as a brush type when cleaning a frame or furniture by adjusting the length of the brush by button operation. In addition, the cleaning module 222 having the suction hole for gaps may have an inlet formed in a narrow nozzle shape to be advantageous for sucking dust and the like by inserting in a narrow gap.

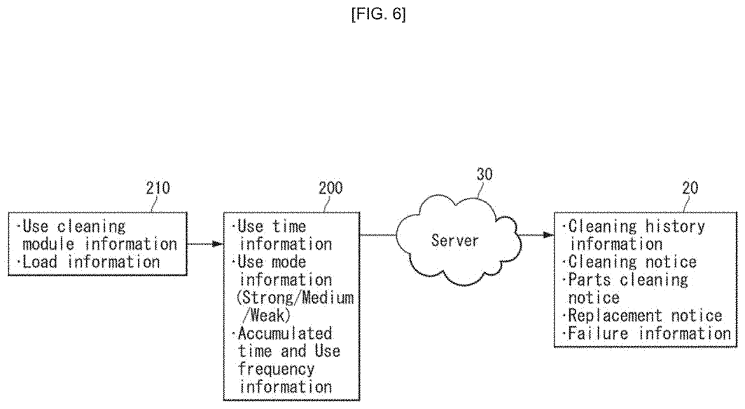

FIG. 6 is a diagram illustrating a control method of a vacuum cleaner 100 according to an embodiment.

The vacuum cleaner 100 according to an embodiment of the present disclosure may be provided with a modular cleaning module 210 that is detachable, and may be used while changing an appropriate cleaning module 210 as necessary.

The cleaner body 200 may receive information and load information of the cleaning module used from the cleaning module 210. For example, a main circuit (MCU: Micro Controller Unit) provided in the cleaner body 200 may determine and store what is the cleaning module 210 currently being used through the current value (or voltage value) measured at the power line connected to the cleaning module 210. Since the current value of the power line may vary depending on the load applied to the cleaning module 210, the main circuit may also store and use the load information or torque information applied to the cleaning module 210. For reference, the torque of the motor is proportional to the load current flowing through the rotor. As the load of the motor increases, the load current increases, and the torque increases to balance with the load so that stable operation can be continued. The relationship between the torque and the load current can be known through a torque characteristic curve.

In addition, the main circuit may store information regarding which cleaning module 210 was used at what time and for what time, that is, usage time information. When the usage mode may be determined into strong/medium/weak according to the rotational force of the suction motor of the cleaner body 200, the main circuit can store the usage time and usage output for each usage mode used by the user. The main circuit may transmit accumulated usage time and usage frequency information for each cleaning module used by the user to the server 30 together with the information.

The server 30 may provide cleaning history information to the user by using the accumulated information. In addition, the server 30 may inform that the cleaning time has arrived by analyzing a cleaning pattern of the user and recommending a cleaning type necessary for the smart device 20 or the vacuum cleaner 100. For example, when analyzing through the accumulated data of the vacuum cleaner 100, if the last of the bedding cleaning has been passed two months, the application of the smart device 20 may inform the user that it is time to proceed with the bedding cleaning.

In addition, the server 30 may inform that the washing time of the cleaning module 210 component has arrived, or may inform that the cleaning module 210 has failed or the replacement time has elapsed.

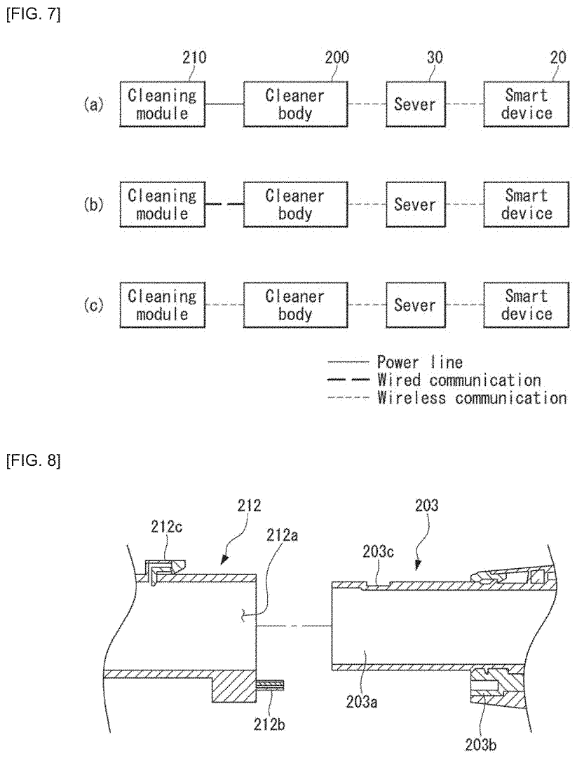

FIG. 7 is a block diagram illustrating a connection relationship of a vacuum cleaner 100.

Referring to FIG. 7 (a), the cleaning module 210 and the cleaner body 200 may be physically connected through the power line, the cleaner body 200 and the server 30 may be connected by wireless communication, and the server 30 and the smart device 20 may be connected by wireless communication.

A coupling part of the cleaning module 210 and the cleaner body 200 may transmit the suction force generated by the cleaner body 200 to the cleaning module 210, and may be provided with a suction pipe that is a passage for moving the dust sucked from the cleaning module 210, and a power line for providing power to the cleaning module 210.

The main circuit of the cleaner body 200 can obtain information related to which cleaning module 210 is coupled, whether it is currently in use, and how much load or torque is applied through the current value (or voltage value) of the power line.

Referring to FIG. 7 (b), the cleaning module 210 and the cleaner body 200 may be physically connected through the power line and wired communication, the cleaner body 200 and the server 30 may be connected by wireless communication, and the server 30 and the smart device 20 may be connected by wireless communication.

A coupling part of the cleaning module 210 and the cleaner body 200 may transmit the suction force generated by the cleaner body 200 to the cleaning module 210, and may be provided with a suction pipe that is a passage for moving the dust sucked from the cleaning module 210, a power line for providing power to the cleaning module 210, and a communication line for transmitting usage information of the cleaning module 210.

The main circuit of the cleaner body 200 can obtain information related to which cleaning module 210 is coupled, whether it is currently in use, and how much load or torque is applied through the information of the communication line. The current (or voltage) information of the power line includes noise, and when the noise is relatively large, it may not be possible to identify information to be obtained from them. In this case, by using a separate communication line, only information to be obtained can be transmitted through a separate line. For example, when a bedding cleaning module is used in combination, it may be difficult to obtain usage information through the power line because the operating current is very weak. In this case, a communication line is provided separately from the power line, it is possible to transmit information without missing information by transmitting the usage information of the cleaning module 210 through the communication line.

Referring to FIG. 7 (c), the cleaning module 210 and the cleaner body 200 may be physically connected through the power line and may be connected through wireless communication, the cleaner body 200 and the server 30 may be connected by wireless communication, and the server 30 and the smart device 20 may be connected by wireless communication.

The cleaning module 210 may be provided with a transmitter for wirelessly transmitting the usage information. The cleaner body 200 may be provided with a receiver for receiving information of the cleaning module 210.

In addition, the main circuit of the cleaner body 200 can obtain information related to which cleaning module 210 is coupled, whether it is currently in use, and how much load is applied through the information of the receiver. Zigbee, Bluetooth, or the like may be used as a means of wireless communication that may be used

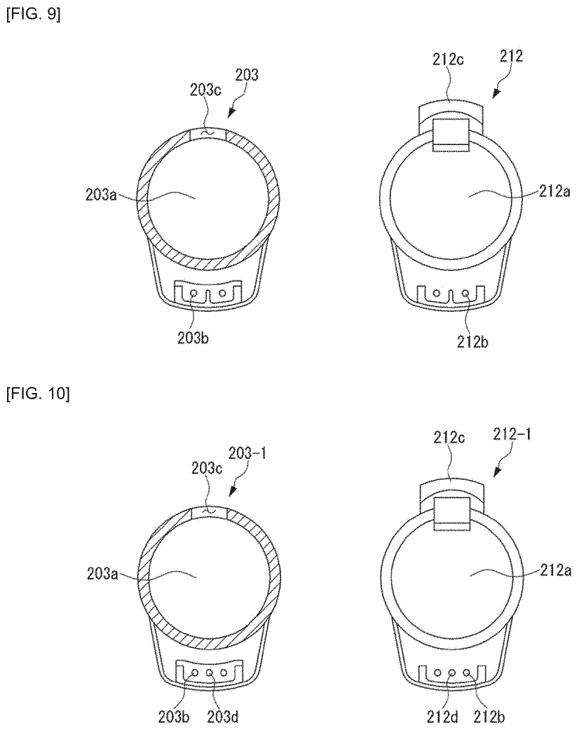

FIG. 8 is a cross-sectional view illustrating a coupling part of a cleaner body 200 and a cleaning module 210 according to a first embodiment, and FIG. 9 is a plan view illustrating coupling parts of a cleaner body 200 and a cleaning module 210 according to a first embodiment, respectively.

The cleaner body 200 may form the connecting part 203 which is connected to the front of the body part 201 and is coupled to the cleaning module 210 or the length adjusting member 220. The connecting part 203 may be provided in a form of a tube protruding in front of the body part 201.

In addition, one end of the cleaning module 210 or the length adjusting member 220 may be formed with the coupling part 212 coupled to the connecting part 203. The coupling part 212 may be provided in a tubular shape in which the connecting part 203 may be accommodated. At this time, the inner diameter of the coupling part 212 may be the same or slightly larger than the outer diameter of the connecting part 203.

The connecting part 203 and the coupling part 212 may be detachably coupled, for example, it may be provided by coupling of a coupling groove 203c formed to be recessed in an outer circumferential surface of the connecting part 203 and a coupling protrusion 212c formed to protrude from an inner circumferential surface of the coupling part 212.

The coupling protrusion 212c may be connected to the coupling part 212 by a hinge, and supported by an elastic member such as a coil spring. That is, when the user inserts the connecting part 203 into the inner space of the coupling part 212, the coupling protrusion 212c is pressed while pressing the elastic member, and when the insertion of the connecting part 203 is completed, the coupling protrusion 212c is fitted into the coupling groove 203c by a restoring force of the elastic member. Therefore, the connecting part 203 and the coupling part 212 can be firmly coupled.

At the time of separation, a pusher provided on the outer circumferential surface of the coupling part 212 may be used. When the user presses the pusher, the coupling protrusion 212c connected thereto is pressed in a state in which the elastic member is pressed. That is, the coupling protrusion 212c may be separated from the coupling groove 203c to separate the connecting part 203 from the coupling part 212.

The connecting part 203 may transmit the suction force generated in the cleaner body 200 to the cleaning module 210, and may be provided with a first suction pipe 203a which is a passage through which dust sucked from the cleaning module 210 moves, and a first power connection part 203b for providing power to the cleaning module 210.

In addition, the coupling part 212 may be provided with a second suction pipe 212a which is a passage through which the suction force of the connecting part 203 is transmitted and a passage through which dust sucked by the cleaning module 210 moves, and a second power connection part 212b for receiving power from the first power connection part 203b.

The first and second power connection parts 203b and 212b may be provided at one side of the first and second suction pipes 203a and 212a, and be provided in a shape in which two terminals are connected. For example, the second power connection part 212b may be provided so that the positive terminal protrudes, and the first power connection part 203b may be provided so that the negative terminal is recessed, and the second power connection part 212b may be inserted.

That is, the suction pipes 203a and 212a and the power connection parts 203b and 212b may be simultaneously connected while the connecting part 203 and the coupling part 212 are coupled to each other.

FIG. 10 is a plan view illustrating a coupling part of a cleaner body 200 and a cleaning module 210 according to a second embodiment, respectively.

The connecting part 203 may be provided with a first suction pipe 203a which is a passage through which the suction force generated in the cleaner body 200 is transmitted to the cleaning module 210, and a passage through which the dust sucked in the cleaning module 210 moves, a first power connection part 203b for providing power to the cleaning module 210, and a first information connection part 203d which is connected to a second information connection part 212d described below to receive information.

The coupling part 212 may be provided with a second suction pipe 212a which is a passage through which the suction force of the connecting part 203 is transmitted and dust sucked from the cleaning module 210 moves, a second power connection part 212b for receiving power from the first power connection part 203b, and a second information connection part 212d which transmits the information of the cleaning module 210 to the main circuit of the cleaner body 200.

The first and second power connection parts 203b and 212b may be provided at one side of the first and second suction pipes 203a and 212a, and be provided in a shape in which two terminals are connected. For example, the second power connection part 212b may be provided so that the positive terminal protrudes, and the first power connection part 203b may be provided so that the negative terminal is recessed, and the second power connection part 212b may be inserted.

In addition, the first and second information connection parts 203d and 212d may be provided adjacent to the first and second power connection parts 203b and 212b, and may be provided in a shape to which one terminal is connected. For example, the second information connection part 212d may be provided so that one terminal protrudes, and the first information connection part 203d may be provided so that the negative terminal is recessed, and the second power connection part 212d may be inserted.

That is, the suction pipes 203a and 212a, the power connection parts 203b and 212b, and the information connection parts 203d and 212d may be simultaneously connected while the connecting part 203 and the coupling part 212 are coupled to each other.

The torque of the motor is proportional to the load current flowing through the rotor. When the load of the motor increases, the load current increases, and the torque increases to balance with the load so that stable operation can be continued. The relationship between the torque and the load current can be known through a torque characteristic curve.

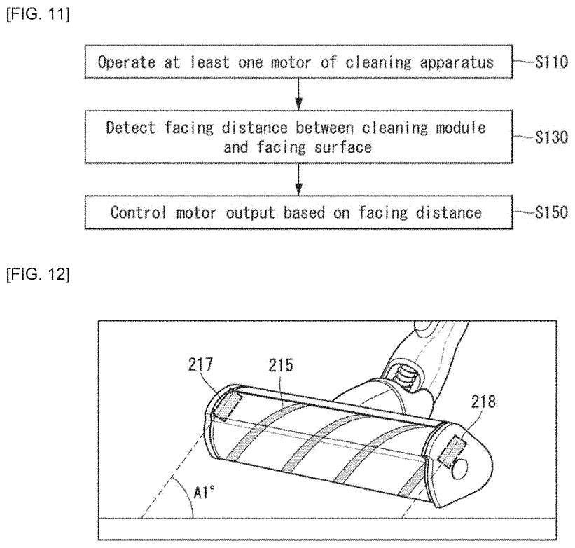

FIG. 11 is a flowchart illustrating a control method of a cleaning apparatus according to an embodiment of the present disclosure.

As illustrated in FIG. 11, a control method (S100) of a cleaning apparatus according to an embodiment of the present disclosure includes step S110, step S130, and step S150. The control method of the cleaning apparatus in FIG. 11 may be performed by the cleaning apparatus 100 in FIG. 1, the cleaning apparatus 100, the Internet 40, and the smart device 20 in FIG. 2, the customized cleaning information providing apparatus 100 in FIG. 3, the AI device 50 in FIG. 4, the cleaning apparatus body 200 and the cleaning module 210 in FIG. 5, the cleaning apparatus body 200 and the cleaning module 210 in FIG. 6, and at least one of the cleaning apparatus body 200, the cleaning module 210, the server 30, or the smart device 20 in FIG. 7. In the following description, it is assumed and described that the cleaning apparatus (the cleaning apparatus body 200 and/or the cleaning module 210) performs the control method of the cleaning apparatus, but the present disclosure need not be particularly limited thereto. A detailed description is as follows.

First, the cleaning apparatus may operate at least one motor of the cleaning apparatus (S110).

Here, the cleaning apparatus may include a suction motor included in the cleaning apparatus body and a nozzle motor included in the cleaning module. The suction motor may generate a suction force which allows external air of the cleaning apparatus to be suctioned through the cleaning module. Here, the nozzle motor may rotate the brush of the cleaning module according to the control of a processor of the cleaning module. For example, the brush may wrap the nozzle motor so as to rotate jointly according to the rotation of the nozzle motor.

More specifically, the processor of the cleaning apparatus body operates/rotates the suction motor to allow the external air and foreign substances included in the air to be suctioned into the cleaning apparatus body through the cleaning module. Here, the processor of the cleaning module operates/rotates the nozzle motor of the cleaning module to remove foreign substances on the floor surface or the wall surface which is in contact with the cleaning module and transfer the foreign substances to the cleaning apparatus body.

Next, the cleaning apparatus may detect a facing distance which is a distance to a facing surface of the cleaning module (S130).

Here, the facing distance may include a distance between the cleaning module and the floor surface facing the cleaning module. Further, the facing distance may include a distance between the cleaning module and the wall surface facing the cleaning module. Here, the floor surface may mean a surface parallel to a cleaning surface of the cleaning module. Here, the wall surface may mean a surface vertical to a cleaning direction of the cleaning module while being parallel to a normal of the cleaning surface.

The cleaning module may simultaneously detect the facing distance between the cleaning module and the floor surface and the facing distance between the cleaning module and the wall surface. For example, the cleaning module may include a distance sensor for simultaneously detecting the facing distance between the cleaning module and the floor surface and the facing distance between the cleaning module and the wall surface. Here, the distance sensor may be provided inside the cleaning module at a specific angle in order to simultaneously detect the facing distance between the cleaning module and the floor surface and the facing distance between the cleaning module and the wall surface. That is, a first direction directed by the distance sensor, and the floor surface may form an acute angle. Further, the first direction directed by the distance sensor, and the wall surface may also form the acute angle.

Then, the cleaning apparatus may control an output of each of at least one motor of the cleaning apparatus based on the facing distance described above (S150).

For example, the output of the nozzle motor may mean a rotation per minute (RPM) or a rotational torque of the nozzle motor. Here, the processor of the cleaning module may variably control the RPM of the nozzle motor or the rotational torque of the nozzle motor based on the facing distance detected by the distance sensor.

As another example, the output of the suction motor may mean the RPM or the rotational torque of the suction motor. That is, the processor of the cleaning apparatus body may variably control the RPM of the suction motor or the rotational torque of the suction motor based on the facing distance detected by the distance sensor.

Table 1 illustrates a specific example of controlling the output of at least one motor according to a detection value of the distance sensor.

TABLE 1

| | First | Second | Third |
|---|---|---|---|
| Configuration | mode | mode | mode |
| Distance | D < D_{TH1} | D_{TH2} > | D_{TH2} < D |
| sensor | sensing | D > D_{TH1} | |
| | | sensing | |
| Processor | Judgment | Judgment | Judgment |
| | of wall | of floor | of floor |
| | surface | surface | surface |
| | contact | contact | separation |
| Motor | Increase | Predetermined | Decrease of |
| | of output | output | output of |
| | of suction | | nozzle motor |
| | motor | | |

Here, the first mode, the second mode, and the third mode are distinguished according to an output ratio of the motor (brush). For example, the first mode may be defined as a mode of the increase in output of the suction motor and may become a case where the output of the suction motor is 70 to 100% of a maximum output value. For example, the second mode may be defined as a normal output mode, and the outputs of the suction motor and the nozzle motor may become a predetermined value, a value input by the user, or 30 to 70% of the maximum output value. For example, the third mode may be defined as a nozzle motor stop mode and may become a case where the output of the nozzle motor is 0 to 30% of the maximum output value. Here, D represents the detection value of the distance sensor, and DTH1 and DTH2 represent predetermined threshold values of the facing distances. For example, DTH1 may become a facing distance lowerlimit value which is a reference value for judging whether to enter the first mode from the second mode. For example, DTH2 may become a facing distance upperlimit value which is a reference value for judging whether to enter the third mode from the second mode. As illustrated in Table 1, when the detection value D of the distance sensor is between DTH1 and DTH2, the processor (e.g., the control unit 101 of FIG. 2, the control unit 101 of FIG. 3, and the AI processor 51 of FIG. 4) of the cleaning apparatus body, and the processor of the cleaning module may operate the motor according to the second mode among the first to third modes.

When the D value of the distance sensor becomes smaller than DTH1, the processor of the cleaning apparatus body may operate the motor in the second mode in the first mode. That is, when the D value of the distance sensor becomes smaller than DTH1, the processor may increase the output of the motor up to a maximum value.

When the D value of the distance sensor becomes larger than DTH2, the processor of the cleaning module may operate the nozzle motor in the second mode to the third mode. That is, when the D value of the distance sensor becomes larger than DTH2, the processor of the cleaning module may increase the output of the nozzle motor up to a minimum value.

FIG. 12 illustrates a cleaning module according to an embodiment of the present disclosure.

As illustrated in FIG. 12, according to an embodiment of the present disclosure, the cleaning module (the cleaning module 210 in FIGS. 5, 6, and/or 7) may include a nozzle motor 215 surrounded by the brush. As described above, the nozzle motor may become a cylindrical form in order to suction the foreign substances of the floor surface. The nozzle motor may be rotated/operated by the cleaning module or the processor of the cleaning module.

Further, the cleaning module may include a plurality of distance sensors. For example, the plurality of distance sensors may include a first distance sensor 217 provided at one side of the cleaning module and a second distance sensor 218 provided at the other side, and need not be particularly limited thereto.

Directing directions of the first distance sensor and the second distance sensor may form an acute angle AI with the cleaning surface (floor surface) of the cleaning module. That is, the first distance sensor and the second distance sensor may detect a distance value between the wall surface and each distance sensor while detecting a distance value between the floor surface and each distance sensor.

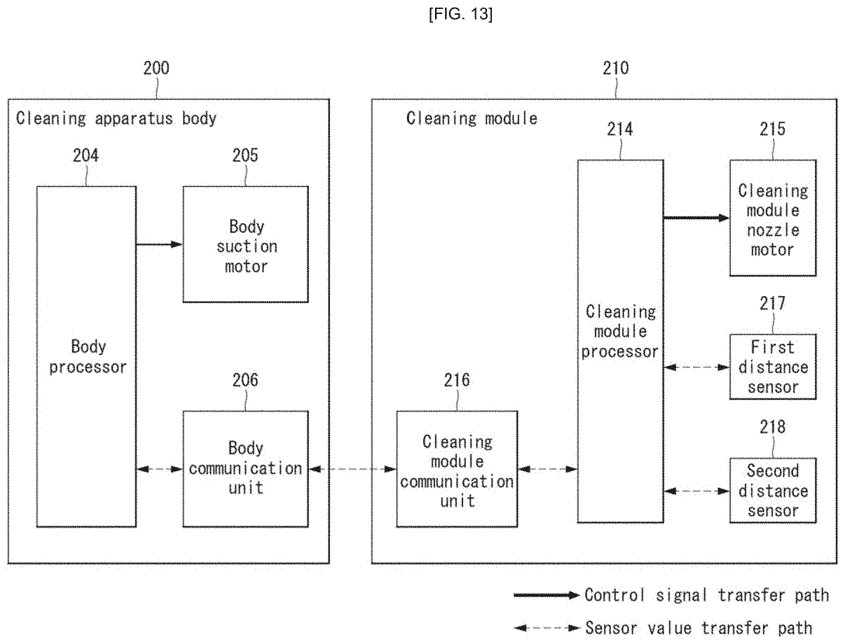

FIG. 13 is a block diagram of a cleaning apparatus body and a cleaning module according to an embodiment of the present disclosure and FIG. 13 is a block diagram of a cleaning apparatus body and a cleaning module according to another embodiment of the present disclosure.

As illustrated in FIG. 13, according to an embodiment of the present disclosure, the cleaning apparatus body 200 may include a body processor 204, a body suction motor 205, and a body communication unit 206. Here, the body processor may control operating/rotation of the body suction motor.

Further, the body processor may receive the distance sensor value from the cleaning module by controlling the body communication unit. More specifically, the body processor may receive the distance sensor value, and variably control the output of the body suction motor based on the received distance sensor value.

For example, when the distance sensor value is acquired by the cleaning module, the body processor may generate distance information between the cleaning module and the facing surface by using the distance sensor value. As another example, when the distance sensor value is acquired by the cleaning module, the processor of the cleaning module may generate the distance information between the cleaning module and the facing surface by using the distance sensor value, and transfer the generated distance information to the body processor.

When the distance between the cleaning module and the facing surface (wall surface) changes from a predetermined facing distance lowerlimit value or more to a value less than the facing distance lowerlimit value. For example, the body processor may increase the output of the body suction motor to 100% of the maximum value.

The cleaning module 21 may include a cleaning module processor 214, a cleaning module nozzle motor 215, a first distance sensor 217, a second distance sensor 218, and a cleaning module communication unit 216. Here, the cleaning module processor may control, and rotate/operate the cleaning module nozzle motor 215.

Further, the cleaning module processor may acquire the distance sensor values detected by the first distance sensor and the second distance sensor, and generate the distance information between the cleaning module and the facing surface by using the distance sensor values. Here, the cleaning module processor may variably control the output of the cleaning module nozzle motor based on the generated distance information.

When the distance between the cleaning module and the facing surface (floor surface) changes from a value less than a predetermined facing distance upperlimit value to the facing distance upperlimit value or more, the cleaning module processor may decrease the output of the cleaning module nozzle motor. For example, the cleaning module processor may stop the output of the cleaning module nozzle motor.

Meanwhile, as illustrated in FIG. 13, in an embodiment of the present disclosure, the cleaning module processor may transmit the distance sensor value or the distance information to the body processor through the cleaning module communication unit and the body communication unit. That is, in the case of FIG. 13, the cleaning module processor may transmit the distance sensor value or the distance information to the body processor through wireless communication by using the cleaning module communication unit and the body communication unit performing the wireless communication.

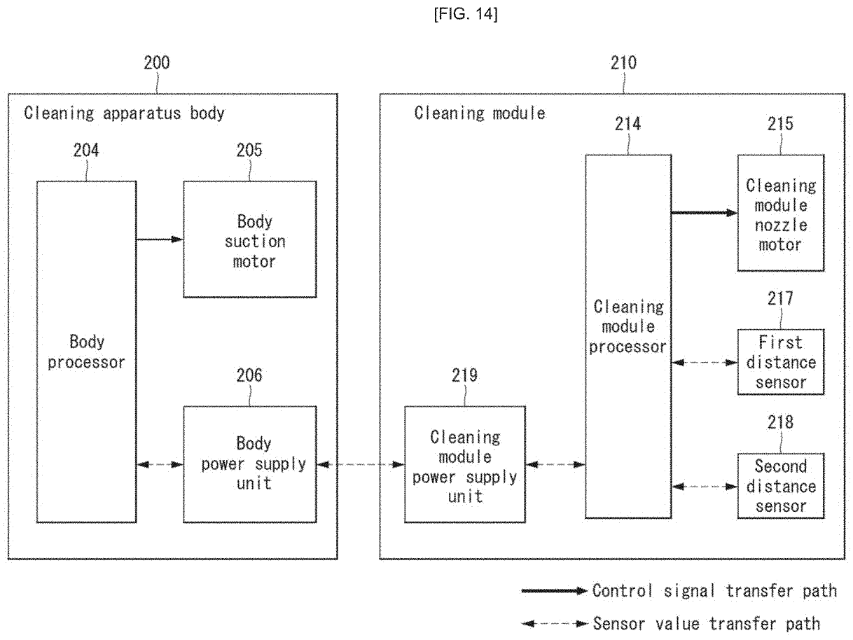

However, as illustrated in FIG. 14, in another embodiment of the present disclosure, a cleaning module processor may transfer a distance sensor value or distance information to a body processor 204 through a cleaning module power supply unit 219 and a body power supply unit 209. That is, in the case of FIG. 14, the cleaning module processor may transmit the distance sensor value or the distance information to the body processor through the cleaning module power supply unit and the body power supply unit performing power line communication. For example, the cleaning module processor may transmit the distance sensor value or the distance information to the body processor by using a current waveform through a power line between the cleaning module power supply unit and the body power supply unit supplying power to the cleaning module.

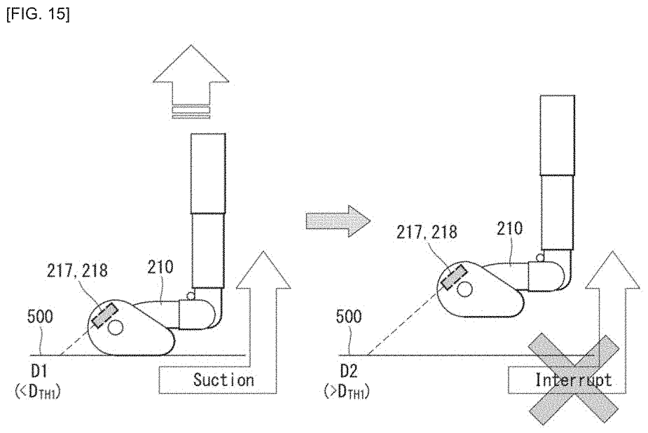

FIG. 15 illustrates one example of a process of controlling a nozzle motor based on a distance sensor value.

As illustrated in FIG. 15, first, a plurality of distance sensors 217 and 218 of the cleaning module may detect a facing distance D1 between a floor surface 500 which is the facing surface, and the cleaning module 210. For example, the plurality of distance sensors may detect the facing distance D1 for a predetermined period, and transfer the detected facing distance value to the processor of the cleaning module.

When the facing distance D1 detected at a first time is smaller than DTH1 which is the facing distance upperlimit value, the cleaning module processor may operate the cleaning module nozzle motor within a predetermined range and the body processor may operate the body suction motor within a predetermined range to thereby suction the foreign substances on the floor surface to the cleaning apparatus body through the cleaning module.

When the cleaning apparatus moves vertically in a normal direction of the floor surface and a facing distance D2 detected at a second time is larger than DTH1 which is the facing distance upperlimit value, the cleaning module processor may decrease the output of the cleaning module nozzle motor. For example, the cleaning module processor may interrupt operating/rotation of the cleaning module nozzle motor.

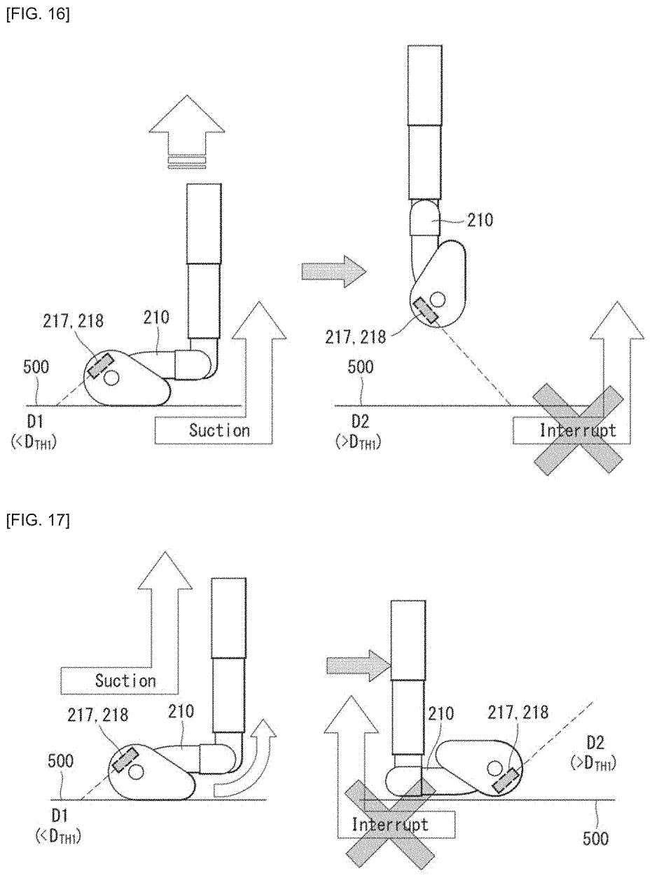

FIG. 16 illustrates another example of the process of controlling the nozzle motor based on the distance sensor value.

As illustrated in FIG. 16, when the cleaning apparatus moves vertically in the normal direction from the floor surface while the foreign substances are suctioned, and the facing distance D1 becomes larger than DTH1 which is the facing distance upperlimit value, the cleaning module processor may interrupt operating/rotation of the cleaning module nozzle motor.

FIG. 17 illustrates yet another example of the process of controlling the nozzle motor based on the distance sensor value.

As illustrated in FIG. 17, when the cleaning module 210 is overturned according to the manipulation of the user at the second time while the foreign substances are suctioned at the first time, directions which the plurality of distance sensors 217 and 218 of the cleaning module face may form the acute angle with the normal direction of the floor surface.

As a result, when the facing distance D2 of the plurality of distance sensors of the cleaning module at the second time becomes larger than DTH1 which is the predetermined facing distance upperlimit value, the cleaning module processor may interrupt the operating/rotation of the cleaning module nozzle motor.

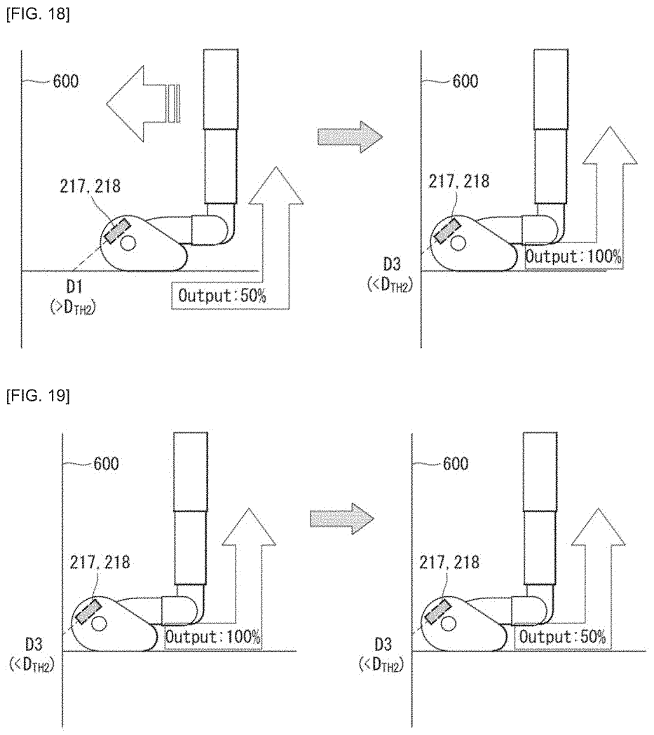

FIG. 18 illustrates one example of a process of controlling a suction motor based on the distance sensor value.

As illustrated in FIG. 18, when the facing distance value D1 acquired by the plurality of distance sensors 217 and 218 at the first time is larger than DTH2 which is the predetermined facing distance lowerlimit value, the cleaning module processor may operate/rotate the nozzle motor by setting the output of the cleaning module nozzle motor to 50% which is a predetermined output value and the body processor may operate/rotate the suction motor by setting the output of the body suction motor to 50% which is a predetermined output value.

When the facing distance D3 acquired at the second time when the cleaning apparatus moves to the wall surface 600 is smaller than DTH2 which is the predetermined facing distance lowerlimit value, the cleaning module processor may transfer the facing distance sensor value D3 to the cleaning apparatus body.

When the facing distance sensor value D3 is transferred, the body processor of the cleaning apparatus body may increase the output of the boy suction motor of the cleaning apparatus body from 50% to 100%.

FIG. 19 illustrates another example of the process of controlling the suction motor based on the distance sensor value.

As illustrated in FIG. 19, when the facing distance D3 detected by the plurality of distance sensors 217 and 218 at the first time is smaller than the predetermined facing distance lowerlimit value DTH2, the body processor may increase the output of the body suction motor from 50% to 100% which is the output value set by the user similarly to the second time described in FIG. 19.

When a predetermined time (e.g., 3 seconds) elapsed after the first time, the body processor may decrease the output of the body suction motor from 100% to 50% which is the value set by the user in the related art.

Some embodiments or other embodiments of the present disclosure described above are not mutually exclusive or distinct from one another. Some embodiments or other embodiments of the present disclosure described above may be used in combination with or combined with each configuration or function.

For example, it means that configuration A described in specific embodiments and/or drawings and configuration B described in other embodiments and/or drawings may be combined. In other words, even when the combination between the configurations is not described directly, it means that the combination is possible except when it is described that the combination is impossible.

The above detailed description should not be construed as limiting in all respects but should be considered as illustrative. The scope of the present disclosure should be determined by reasonable interpretation of the appended claims, and all changes within the equivalent scope of the present disclosure are included in the scope of the present disclosure.

1. A control method of a cleaning apparatus, comprising:
operating at least one motor for suctioning air outside the cleaning apparatus;
acquiring a facing distance between a cleaning module of the cleaning apparatus and a facing surface of the cleaning module while the at least one motor is operating; and
controlling an output of the at least one motor based on the facing distance.

2. The method of claim 1, wherein in the controlling, when the facing distance is larger than a predetermined upperlimit value, the output of the at least one motor is decreased.

3. The method of claim 1, wherein in the controlling, when the facing distance is larger than a predetermined upperlimit value, the operating of the at least one motor is stopped.

4. The method of claim 1, wherein in the controlling, when the facing distance is larger than a predetermined upperlimit value, an output of a nozzle motor of the cleaning module among the at least one motor is controlled.

5. The method of claim 1, wherein in the controlling, when the facing distance is smaller than a predetermined lowerlimit value, the output of the at least one motor is increased.

6. The method of claim 1, wherein in the controlling, when the facing distance is smaller than a predetermined lowerlimit value, the output of the at least one motor is set to a maximum value.

7. The method of claim 1, wherein in the controlling, when the facing distance is larger than a predetermined lowerlimit value, an output of a body suction motor of the cleaning apparatus among the at least one motor is controlled.

8. The method of claim 1, wherein the controlling includes changing the output of the at least one motor from a first output value to a second output value based on a change of the facing distance, and
wherein the method further comprises restoring the output of the at least one motor from the second output value to the first output when a predetermined time elapsed after the controlling.

9. The method of claim 1, wherein the facing distance is generated by using distance sensor values of a plurality of sensors directing a direction which forms an acute angle with a normal of a bottom surface.

10. The method of claim 9, wherein the plurality of sensors are included in the cleaning module, and
in the acquiring of the facing distance, the facing distance is acquired from the cleaning module through power line communication.

11. A cleaning apparatus including a cleaning module and a body, comprising:
at least one motor for suctioning air outside the cleaning apparatus;
at least one sensor included in the cleaning module, and detecting a facing distance between the cleaning module and a facing surface while the at least one motor is operating; and
at least one processor controlling an output of the at least one motor based on the facing distance.

12. The cleaning apparatus of claim 11, wherein when the facing distance is larger than a predetermined upperlimit value, the processor decreases the output of the at least one motor.

13. The cleaning apparatus of claim 11, wherein when the facing distance is larger than the predetermined upperlimit value, the processor stops the operating of the at least one motor.

14. The cleaning apparatus of claim 11, wherein when the facing distance is larger than a predetermined upperlimit value, the processor controls an output of a nozzle motor of the cleaning module among the at least one motor.

15. The cleaning apparatus of claim 11, wherein when the facing distance is smaller than a predetermined lowerlimit value, the processor increases the output of the at least one motor.

16. The cleaning apparatus of claim 11, wherein when the facing distance is smaller than a predetermined lowerlimit value, the processor sets the output of the at least one motor to a maximum value.

17. The cleaning apparatus of claim 11, wherein when the facing distance is smaller than a predetermined lowerlimit value, the processor controls an output of a body suction motor of the cleaning apparatus among the at least one motor.

18. The cleaning apparatus of claim 11, wherein the processor changes the output of the at least one motor from a first output value to a second output value based on a change of the facing distance, and restores the output of the at least one motor from the second output value to the first output value when a predetermined time elapsed after the output value is changed.

19. The cleaning apparatus of claim 11, wherein the at least one sensor directs a direction which forms an acute angle with a normal of a bottom surface.

20. The cleaning apparatus of claim 19, wherein a body processor included in the cleaning apparatus body among the at least one processor acquires the facing distance from a cleaning module processor included in the cleaning module among the at least one processor.
